(19) United States
(12) Patent Application Publication
(10) Pub. No.: US 2006/0010067 A1
(43) Pub. Date: Jan. 12, 2006

(54) Real-time planning and execution with minimum perturbation

(76) Inventors: Ranjit Notani, Southlake, TX (US); Peng Zhao, Irving, TX (US); Mark B. Whipple, Flower Mound, TX (US); Ken McAloon, Charlotte, NC (US)

Correspondence Address: HOWISON & ARNOTT, L.L.P, P.O. BOX 741715, DALLAS, TX, 75374-1715, US

(21) Appl. No.: 10/887,218

(22) Filed: Jul. 8, 2004

(51) Int. Cl. G06Q 40/00; G06F 17/00; G06F 7/00

(52) U.S. Cl. 705/39; 705/30; 707/100

(57) ABSTRACT

Methods and system are disclosed for planning and optimizing plans of a value chain in response to events and exceptions in the value chain with minimal perturbations to the existing plan. When an event or an exception occurs, potential solutions are constructed and evaluated. The potential solutions respect the business process constraints and temporal constraints on transactions, and the true dynamic capacity constraints in the value chain. The impact of the potential solutions on finance and on the existing plan is evaluated. The solution with maximum profit and minimum perturbation to the existing plan is selected and executed. Techniques of achieving the above goals are described.

### TECHNICAL FIELD OF THE INVENTION

The present invention relates to enterprise supply chain logistics planning and execution and, more particularly, to a method and system for real-time planning and execution with minimum perturbation.

### BACKGROUND OF THE INVENTION

In an increasingly global economy, business enterprises of all types are faced with the challenge of managing and optimizing ever more complex supply chains. These supply chains, often called “value chains,” are characterized by a high degree of collaboration, cooperation, and interdependency between the enterprise and other entities or partners in the chain (e.g., raw materials producers, component manufacturers, distributors, and the like). The business goal of managing and optimizing a value chain is to minimize the costs, including inventory holding cost, incurred by all participants in the chain while maintaining a high level of customer service and maximizing profits.

An important aspect of managing the value chain is the execution of an inventory movement plan that strives to maintain the proper levels of inventory across the value chain. This plan typically includes a plurality of actions that need to be taken to maintain the inventory at a certain level while maximizing customer service level. However since the value chain can be so complex and may involve multiple partners, unexpected events and contingencies often occur that adversely impact the inventory levels and the ability of the enterprise to meet demands. For example, a delivery truck may break down causing an interruption in supply, or a storm may cause a large unexpected rise in demand for construction materials. These unexpected events in the value chain, hereinafter referred to as “exceptions,” cause the state of the value chain to deviate from the existing plan. The deviation may be an increase or decrease in inventory at various locations for various items and/or an inability to meet customer demand.

In the previous art, the approach for handling exceptions was to create a totally new plan for the whole value chain in each batch run. A typical batch run occurs once daily, and considers all value chain changes when creating the new plan. Existing planning and execution systems use the batch-run approach.

There are some major problems with this traditional batch run approach to planning. Firstly, the latency between two planning runs is at least a day and could be as long as a week. During the latency period of time, the state of the value chain is changing. As more changes occur, the planning system has an increasingly more ‘stale’ view of the state of the value chain, and the plan will quickly be rendered useless. Running the batch planning more frequently seems an obvious solution to the problem. But in reality, since the batch planning system plans the whole value chain at once, it could take a significant amount of time to complete (hours), therefore limiting the frequency that it can be run.

Additionally, the batch run approach usually creates a new plan without considering the decisions of the old one. The new plan may be dramatically different plan from the previous one. The new plan creates new actions to compensate for new exceptions as well as possibly creating different transactions to handle exceptions that the old plan solved. The new plan could also create transactions that negate effects of the old plan. Such dramatically different plans from day to day will typically cause massive disruption to the operation of the business, especially in the near term. This makes the current prior art approach impractical for near term execution.

A new approach is needed to compute a value chain plan incrementally and optimally to compensate for exceptions with minimum disruptions to the participants in the value chain.

### SUMMARY OF THE INVENTION

Embodiments of the invention are directed to a method and system for managing and optimizing a value chain. Exemplary methods and systems of the invention may include a value chain management program designed to react to the new state of the value chain caused by one or more exceptions in the value chain. An exemplary embodiment can create an optimal new plan while minimizing perturbations to the existing executing plan. An example of a problem caused by an exception may be an inventory violation such as stock-out.

When an event in the value chain occurs, the program uses real-time data to evaluate different potential plans for alleviating or eliminating the problems caused by the exception with minimal cost and minimal changes to the existing plan. If the benefits of the best plan, among the plans being evaluated, outweighs the cost of implementing the plan (including cost of change), the program will adapt that plan and alter the existing plan by generating new actions. For example, if a stock-out inventory violation can be solved by placing a new order to an upstream supplier or expediting an existing plan and the financial benefits of expediting an existing order exceeds that of placing a new order, the system will place an order for the inventory.

If the cost of alleviating a problem (including cost of change) caused by an exception exceeds the benefit, then the program will leave the problem unresolved. If for example an inventory overage exists, and returning goods to a supplier exceeds the cost of storage of the goods until consumption, then the system will recognize this and no actions will be taken.

The system will also consider additional constraints such as disruption to the value chain, and may refrain from creating actions because it would cause undue perturbation to the value chain. For example, if a solution consisted of creating an order for inventory to overcome a temporary shortfall, and shortly thereafter returning the inventory to resolve an overage, the system would recognize the perturbation caused to the value chain and not place the order.

All exceptions do not cause problems, and the system will recognize when no problems are caused, and not attempt to resolve the exception.

A number of new exemplary techniques are described herein to minimize perturbation to the existing plan. The techniques to minimize the perturbation to the existing plan include: 1) Favoring changes in the far term over changes in the near term; 2) Respecting process constraints around existing business transactions; 3) Respecting temporal constraints around existing business transactions; 4) Respecting true dynamic capacity constraints in the value chain; 5) Allowing short-lived exceptions to remain unresolved if their cost of resolution exceeds benefit of solution (including cost incurred in the future); 6) Evaluating the cost and benefit of alleviating or eliminating the problems caused by the exception in determining the solution; 7) If an action is warranted, alleviating or eliminating the problems caused by the exception, efforts are made to modify an existing transaction first before creating a new transaction; and 8) Respecting the decision constraints that have been created by other decision making agents.

### BRIEF DESCRIPTION OF THE DRAWINGS

A more complete understanding of the method and apparatus of the present invention may be obtained by reference to the following Detailed Description when taken in conjunction with the accompanying Drawings, wherein:

FIG. 1 illustrates an exemplary enterprise value chain;

FIG. 2 illustrates an exemplary value chain management program according to embodiments of the invention;

FIG. 3 illustrates an exemplary projected on-hand inventory for a typical enterprise before planning;

FIG. 4 illustrates an exemplary projected on-hand inventory for the enterprise after planning;

FIG. 5 illustrates an exemplary on-hand inventory for the enterprise when an exception has occurred; and

FIG. 6 illustrates an exemplary flowchart that may be used with the value chain management program according to embodiments of the invention. [FIG. 7 illustrates exemplary temporal constraints on an exemplary transaction.

### DETAILED DESCRIPTION OF THE INVENTION

As mentioned above, embodiments of the invention provide a system and method for creating a new plan in response to events and exceptions in the value chain while minimizing the perturbations to the existing plan. The exemplary value chain has basically two sides: planning and execution. The planning side addresses the long-term decisions of the enterprise, such as what items the enterprise will sell in the coming months, over the next year, or over next five years, how much the enterprise will sell, and what business activities need to happen to support that demand forecast. The execution side addresses the short-term decisions of the enterprise, such as whom to buy from, whom to sell to, where the price should be set, and so on. Execution side issues often need to be addressed on a day-to-day or week-to-week basis in order for the enterprise to function properly.

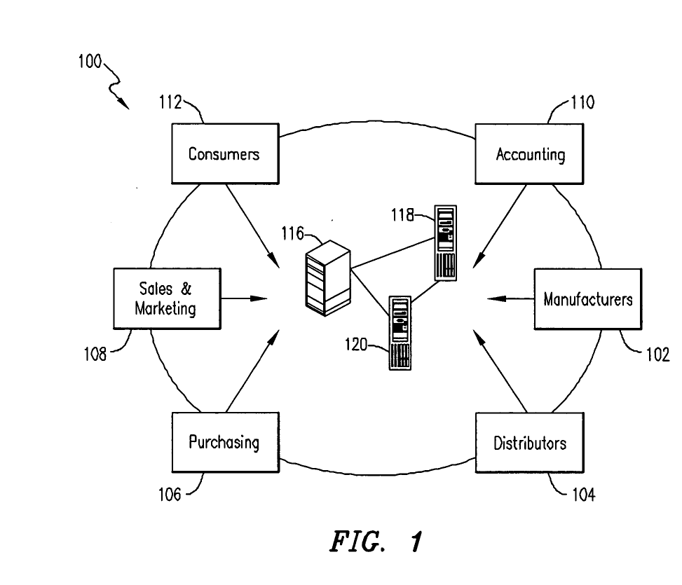

Referring now to FIG. 1, an example of a value chain 100 (or portion thereof) for a typical enterprise is shown. As can be seen, the value chain 100 includes both external entities, such as manufacturers 102 and distributors 104, as well as entities that are internal to the enterprise, such as purchasing 106, sales and marketing 108, and accounting 110. These entities collaborate and share information with one another to provide value to each other and to the enterprise in various ways that are well-known and need not be described here. In some cases, consumers 112 may also be viewed as part of the value chain 100.

The internal and external entities of the value chain 100 are linked together by a value chain management system 114. Through the value chain management system 114, the enterprise and the entities may share data and information, schedule deliveries, and generally work together to achieve the business goal of minimizing inventory for each entity. The value chain management system 114 may include one or more computers/servers 116, 118, and 120 that typically reside at the enterprise, but may be connected to the external entities over a network (not expressly shown). The computer servers 116-120 store and execute a value chain management program on a computer readable medium that includes various application tools for inventory control, purchasing, accounting, and the like. The value chain management program allows the various entities of the value chain 100 to collaborate with one another and with the enterprise.

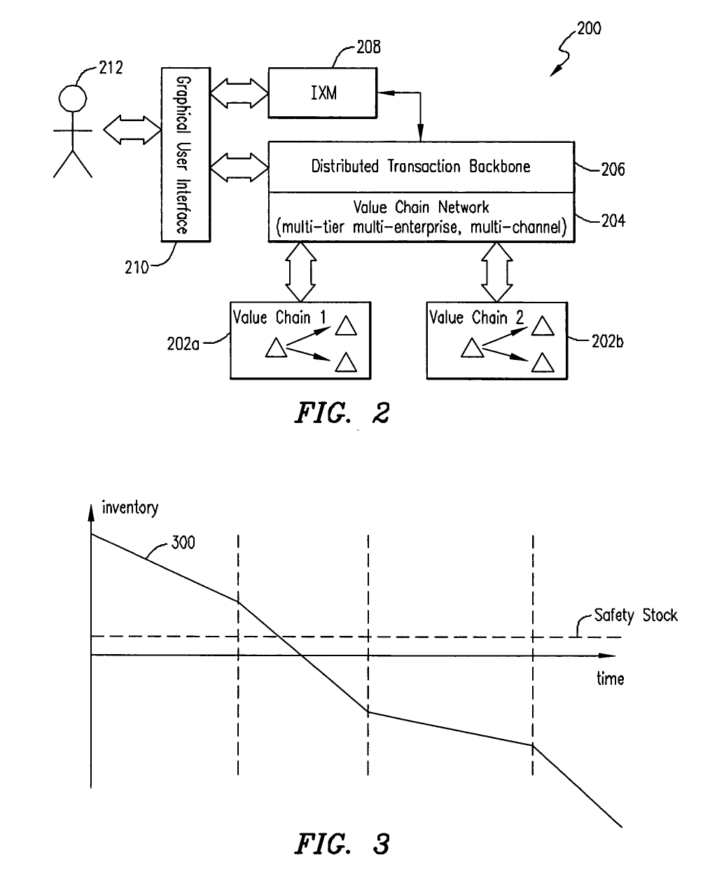

FIG. 2 illustrates the architecture of an exemplary value chain management program 200 according to embodiments of the invention. As can be seen, the value chain management program 200 comprises a number of data and functional components, including value chain components 202a and 202b, which form the foundation layer of the value chain management program 200. The value chain components 202a and 202b receive data pertaining to the various transactions between the enterprise and the entities in the value chains. This transaction data is provided to a value chain network 204, where the data may be shared across the other components of the value chain management program 200. The value chain network 204 may be a multi-tier, multi-enterprise, and/or multi-channel value chain network.

A distributed transaction backbone 206 processes the data from the various types of transactions, including purchase orders, inventory and shipment transactions, as well as custom transactions for unique business processes. The distributed transaction backbone 206 uses the transaction data to manage the execution of the various transactions across the entities, organizations, and systems in the value chains, and to generate new transactions, and modify or cancel existing transactions as needed. Moreover, the distributed transaction backbone 206 is a distributed technology and therefore is capable of uniting traditionally separate applications and communication technologies.

The value chain management program 200 further includes an intelligent execution module 208 that is designed to intelligently come up with plans to cope with the ever changing state of the value chain and minimize the effects caused by events in the value chain, thereby reducing or eliminating perturbations to the existing plan. Also present is a user interface 210 that allows a user 212 (e.g., enterprise employee) to interact with the intelligent execution module 208. Operation of the intelligent execution module 208 will now be described.

When an event or an exception to the value chain occurs, the intelligent execution module 208 is first informed or otherwise provided with information about the event or the exception. The information may be reported manually by the user 212 through the user interface 210, or it may be picked up automatically through the distributed transaction backbone 206. The intelligent execution module 208 then detects if there is any problem caused by events or exceptions. If there is no problem, no action will be taken. If events or exceptions cause problems, the intelligent execution module 208 constructs and evaluates several potential solutions or changes to alleviate the problems. The potential solutions respect the business process constraints and temporal constraints on transactions, and the true dynamic capacity constraints in the value chain. The impact of the potential solutions on finance and on the existing plan are evaluated. The solution with maximum profit and minimum perturbation to the existing plan is selected and executed.

The driving force behind minimizing perturbation is cost. Ideally, a value chain in accordance with the embodiments of invention strives for minimum perturbation and minimum costs while maintaining maximum profit. Any changes to an existing plan cost the enterprise money. If these changes occur in the near term, the cost tends to be higher than if the changes occur in the far future. For example, if there is unsatisfied demand at a store, it is much less costly to fill the demand if the system can take action well in advance of the shortfall as opposed to trying to resolve the shortfall at the last minute and suffering the costs of short-term acquisition. To insure that the plan favors changes in the far future over changes in the near future, the invention will attempt to recognize and resolve any exception well in advance of the actual occurrence of the exception. The system has a view of the state of the value chain as time progresses. Some transactions affect the state of the value chain in the near term, while others affect the state of the value chain further in the future. Inventory problems could occur in the near time frame, as well as in the far time frame. This time-based view provides the system the capability to have a forward look into the state of the value chain. Since the system has this forward looking view, it can attempt to solve any exceptions that occur in the most optimal time window surrounding the exception, giving the system much greater reaction time. Because the value chain is given more time to react to the new actions, the cost for implementing the resolution is significantly reduced. This provides the invention significant opportunity to reduce the cost of any corrective measures that must occur.

Before making the final decision as to the viability of a particular resolution to an exception, any actions that would be taken by the invention are applied to the current and future state of the value chain. The overall effects of these actions are then evaluated. If the effects are not beneficial, they will not be applied. Since the system attempts to resolve the exceptions well in advance, it can easily adjust any actions to reduce the perturbation and optimize the economic impact to the value chain. For example, if a stock-out condition exists, the system will create a plan to resolve the exception. After determining a solution (creating an order to replenish the stock-out), the action (a new order in this case) will be applied to the state of the value chain. The system will then analyze the new state of the value chain. If the new state is superior, the action (order) will be applied. If the new state of the value chain is not superior, the new action will not be applied.

The system maintains a view of the state of the value chain as time progresses. It is also aware of the business process constraints that exist in the value chain. Transactions in the value chain must adhere to specific process constraints that are defined by the business processes the enterprise engages in. These process constraints restrict the transitions and states that a transaction must follow. If these constraints are not considered, the system could put the transactions in the value chain in an invalid state, or the system may not be able to produce the most optimal solution. For example, an enterprise might define that a shipment can be changed until appointments for pickup and delivery have been created. After the appointments have been scheduled, the shipment is considered as ‘finalized’ and unchangeable. If an exception exists that could be optimally resolved by changing a shipment, the planning system needs to understand which shipments can be changed without violating process constraints. Traditional planning systems do not understand detailed process constraints, so any attempts to change a shipment could result in invalid value chain transactions. If the traditional planning system tries to change a shipment, it could attempt to change one of the shipments with an appointment. This would put the shipment into invalid state. Alternatively, the traditional planning system could miss the opportunity to change existing shipments that are not associated with an appointment. This would result in a less than optimal solution. Embodiments of the invention understand these detailed process constraints, and can choose which shipments are candidates for change. Various embodiments understand the state of the current transactions in the system and the processes controlling them. Since exemplary embodiments of the invention understand the process constraints, they will not produce transactions that cause the value chain to be in an invalid state. They can also arrive at the optimal solution within the operating process constraints. The perturbation of the value chain is reduced, and the opportunity to maximize the profit potential for the value chain is not lost because the exemplary system understands these process constraints.

Another constraint that traditional planning systems do not consider is temporal constraints. A value chain has specific periods of time during which actions should not be taken on any existing transactions, and no new transactions should be created. For example, an enterprise might define a period of time that an order can be manually reviewed and changed by a buyer, but should not be changed by an automated planning system. This period of time allows the buyer to review an order for accuracy and make decisions about the status of an order. If an automated planning system changes an order during the buyer review period of time, it will cause disruptions to the value chain. FIG. 7 describes an exemplary timeline that an enterprise has defined. As can be seen, as time progresses 700, transactions 701 occur at future dates. For example, order transactions 702 may exist in the near future, out to the far future 703. As time progresses, these transactions change state from orders that can be changed by the planning system 704, to a state that only manual changes can take place 705. As time progresses, the transactions moving into the shipment phase of the transaction, where changes are allowed on the transactions 706. Traditional planning systems do not understand these temporal constraints, and can introduce perturbation or produce erroneous plans. An embodiment of the invention understands these temporal constraints and honors periods of time where behavior of the planning system must differ.

In addition to the constraints described above, the value chain is an evolving system. As time progresses, the state of the value chain is constantly changing due to events that are outside the control of the planning system. External events such as weather or traffic can delay delivery dates of goods. Changes in the transportation equipment (truck, train, airplane) can delay or expedite goods delivery. Labor availability affects scheduled actions in the value chain. These events affect the dynamic real-time capacity availability of the value chain. Typical planning systems estimate the available capacity in the value chain and can not account for real-time changes that occur to the capacity. The problems caused by this inaccurate view of the value chain capacity are magnified in the near future as reaction time is reduced. Because traditional planning systems use estimated or planned capacity, the discovery of the problem usually occurs after the opportunity to fix the problem. For example an enterprise may require that before placing an order, pickup and delivery appointments must be made to reserve transportation capacity in a value chain. If appointment availability is not verified upon order creation, and the capacity not reserved by creating the appointment, the transaction will not be valid. If the appointment is not reserved, there can be no guarantee that the goods can be delivered. Traditional planning systems do not consider such capacity constraints, and will create orders without considering available capacity. The traditional planning system will also leave transactions in an invalid state since there is no appointment associated with the order and no guarantee that the order can be filled (there may be no available capacity). An exemplary embodiment of the invention considers capacity constraints when determining actions to take, and can additionally reserve capacity if required. This insures that the actions taken by the planning system will have the available capacity resources and disruptions to the value chain are minimized. Because the system has a dynamic real-time view of the capacity constraints of the value chain, it can reduce the disruption to the value chain and optimize the profit potential.

Traditional planning systems can introduce perturbation if a solution to an exception does not consider the effects of the solution over a period of time. Typical prior art planning systems use a point-solution approach to exception resolution. They look at a point in time, and determine an overall state of the value chain, and resolve any issues that are discovered at that point in time. The problem with this approach is that the traditional planning system may attempt to resolve a problem that would have been solved naturally, given time. For example, a store may have an inventory shortfall late one afternoon, with a shipment arriving the next day with sufficient inventory to cover the shortfall. A traditional planning system would observe the inventory exception and place an order to rectify the problem. The next day, the shipment would arrive, adding to the available inventory, and could cause an overstock. The traditional system may during a later run, discover the overstock and return goods to solve the overstock exception. These transactions cause unnecessary perturbation to the value chain. An embodiment of the invention would consider effects of solutions over a period of time. If the economic impact of solving the short-term deficiencies is greater than the profit gained by solving the problem, the system of invention will recognize this, and not attempt to solve the exception.

Referring now to FIGS. 3-5, a scenario is shown in which the intelligent execution module 208 may be used to minimize perturbation in an existing plan. FIG. 3 illustrates the projected on-hand inventory (indicated at 300) of an item at a particular site without any supply. In FIG. 3, the vertical axis represents the inventory level for the item and the horizontal axis represents time. As can be seen, without inventory supplies, the inventory will fall below the safety stock level (horizontal dotted line) after a certain period of time. The dotted vertical lines mark three points in time where sales forecasts change.

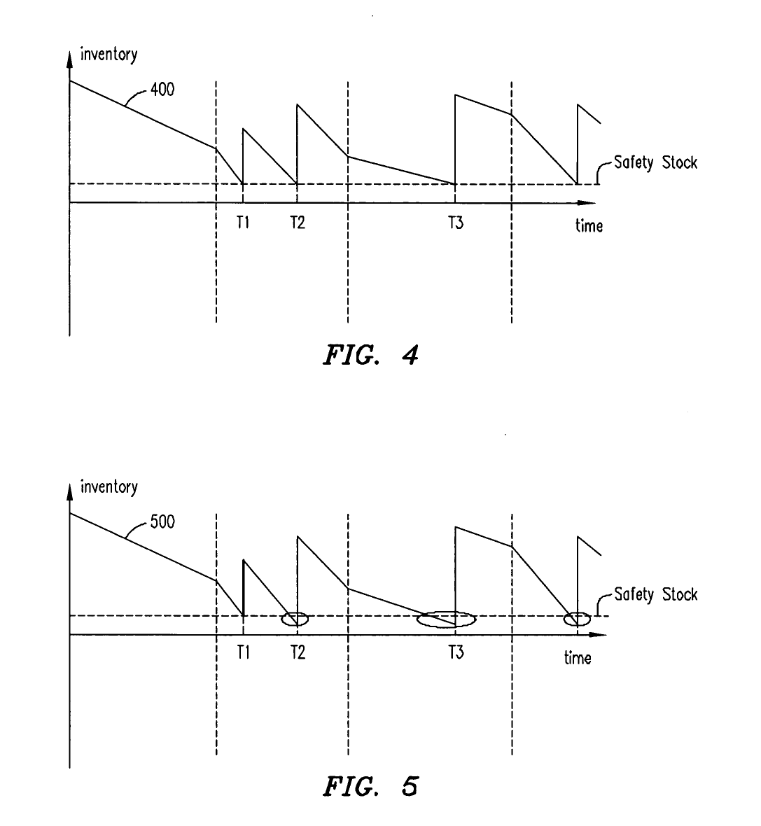

Using the above projected on-hand inventory 300 as a baseline, inventory supplies are planned from the supplier of the site using the value chain management program 200. This is illustrated in FIG. 4, where the horizontal dotted line again represents the safety stock level. The supplier of the site may be, for example, a vendor, distribution center, warehouse, and the like. As can be seen in FIG. 4, with the planned inventory supplies in place, the projected on-hand inventory 400 would not fall below the safety stock level.

Assume now that during the execution of the plan, an exception in the value chain occurs that causes the inventory to deviate from the plan. This is illustrated in FIG. 5, where the on-hand inventory is indicated at 500 and the thick vertical line represents a reduced delivery quantity (i.e., an exception) in the planned inventory. As can be seen, the reduced delivery quantity results in a smaller quantity of on-hand inventory at time T1. If not remedied, the smaller quantity may cause a safety stock violation at times T2 and T3, and will propagate to later times (indicated by the dotted circles).

In such situations, prior art value chain management solutions would alter the existing plan by immediately placing a request for new inventory to correct the reduced quantity at time T1 (The first possible change time or thereabouts for receiving new inventory from the same or another supplier). The intelligent execution module 208 evaluates the cost and financial benefit of letting the enterprise proceed with the safety stock violation at times T2 and T3. In this case, the safety stock violation will only exist for a short period of time and the cost of eliminating the violation exceeds the financial benefit. Therefore, the intelligent execution module 208 allows the safety stock to be used at times T2 and T3.

Another situation where traditional planning systems fail to consider economic effects of the planning solution is the situation when the cost of implementing a solution exceeds the benefit of the solution. For example, an enterprise value chain can consist of a collection of stores supplied by an upstream distribution center. Inventory is sold to the consumer only through the stores. If there is sufficient inventory on hand to support store sales for a considerable time, but the distribution center has a stock-out situation, traditional planning systems will attempt to solve the stock-out that exists at the distribution center. The cost of solving the stock-out may be high because orders may have to be expedited or higher cost shipping methods may be chosen to fulfill the perceived demand in time. The economic benefit for solving the stock-out is low because the only opportunity for profit exists at the stores, which are fully stocked. The traditional prior art planning system will not understand the economic impact of placing the order when the demand is only a perceived demand. An embodiment of the invention understands the economic effects on the value chain over time, and would recognize that placing orders would cause undue perturbation on the value chain, and not place orders for the distribution center. The invention would however, be aware of the consumption rates at the store and take appropriate actions if any of the stores would experience loss of sales due to inventory shortages at a future date.

In many situations, traditional systems create new orders to alleviate or eliminate the problems caused by an exception, such as stock-out. Creating a new order usually involves purchase order approval business process. For example, creating a new order in an enterprise may have to go through buyer review, manager approval, business contact compliance check, finance, and transmitting the purchase order to the supplier. Such business process usually takes long time and thus costs more to the enterprise. On the other hand, modifying an existing order may be less expensive because the business process involved is a lot simpler and less costly. For example, store may have a stock-out of an item because of a promotion of the item. There is a shipment of the item may be in the yard of the distribution center waiting for process. Instead of creating a new order, the embodiment of the invention will expedite the shipment in the yard so that the store will receiving the shipment earlier than planned and resolve the stock-out. In this case expediting a shipment is a lot less expensive than creating a new order and the stock-out can be eliminated more promptly.

In a typical enterprise, many computer software applications are deployed to run the business process. The embodiment of the invention will collaborate with other software applications to achieve the business goals of the enterprise in managing the value chain. In such an operating environment, some decisions are made in other software applications, some times called agents. Such decisions are made based on constraints not available to the embodiment of this invention. For example, the federal government recently passed a regulation that limits the number of hours a truck driver can drive every day. Such constraints can be passed to and followed by the embodiment of this invention.

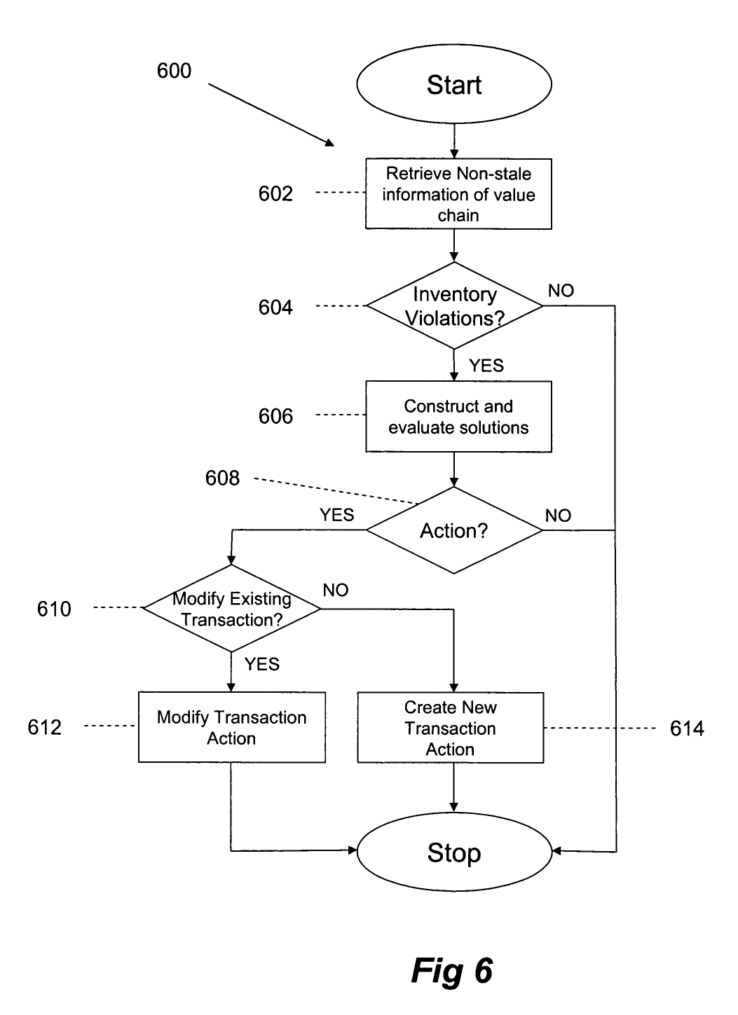

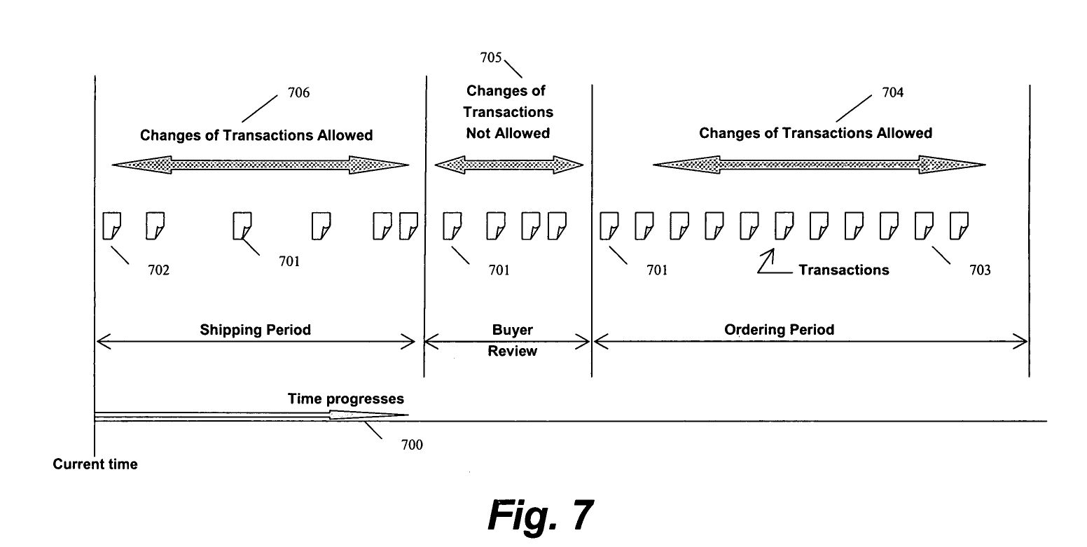

FIG. 6 is a flowchart 600 illustrating a method of managing and optimizing the value chain with minimal perturbations to an existing plan that may be used with the intelligent execution module 208. The flowchart 600 starts when an event or an exception has occurred in the value chain and the value chain management program 200 attempts to come up with a solution. At step 602, the intelligent execution module 208 retrieves non-stale, real-time information from the value chain. At step 604, the intelligent execution module 208 examines the value chain for any inventory violations. If there is no inventory violation, the intelligent execution module 208 will stop without any action. If there are inventory violations, the intelligent execution module 208 precedes to step 606. At step 606, the intelligent execution module 208 constructs and evaluates potential solutions. If at the end of step 606, the intelligent execution module 208 decides that no action is beneficial, it will stop without any action. If at step 606 the intelligent execution module 208 finds one of the solutions that is financially beneficial and causes minimal perturbation to the existing plan, it will implement the solution.

At step 610, the intelligent execution module 208 decides if it is possible to implement the solution selected by modifying an existing transaction. If the intelligent execution module 208 decides to modify an existing transaction, it will do that in step 612. Otherwise, the intelligent execution module 208 creates a new transaction in step 614.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

What is claimed is:

1. A computerized method of managing and optimizing a value chain in response to the new state of the value chain caused by events and exceptions in the value chain and creating an optimal new execution plan while minimizing perturbations to the existing execution plan, comprising:
retrieving latest information of a value chain from the database;
searching for exceptions in the affected portion of said value chain;
constructing potential solutions that optimize said value chain;
evaluating said solutions that optimize said value chain;
selecting one solution among said solutions that provides the most financial benefits with minimal perturbation to the existing execution plan; and
implementing said solution by creating new actions.

2. The method according to claim 1, further comprises detecting exceptions in said portion of said value chain.

3. The method according to claim 1, further comprises constructing said solutions to optimize said value chain.

4. The method according to claim 3, wherein constructing said solutions that optimize said value chain further comprises favoring changes in far term over changes in near term.

5. The method according to claim 3, wherein constructing said solutions that optimize said value chain further comprises respecting process constraints around existing business transactions.

6. The method according to claim 3, wherein constructing said solutions that optimize said value chain further comprises respecting temporal constraints around said transactions.

7. The method according to claim 3, wherein constructing said solutions that optimize said value chain further comprises respecting true dynamic capacity constraints in said value chain.

8. The method according to claim 3, wherein constructing said solutions that optimize said value chain further comprises respecting the decisions and constraints imposed by other decision making agents.

9. The method according to claim 3, wherein constructing said solutions that optimize said value chain further comprises allowing short-lived said exceptions to remain unresolved if the cost of resolution exceeds benefit of solution.

10. The method according to claim 1, wherein evaluating said solutions that optimize said value chain further comprises calculating the cost and the financial benefit of said solutions.

11. The method according to claim 1, wherein evaluating said solutions that optimize said value chain further comprising evaluating the impact of said solutions on said existing execution plan.

12. The method according to claim 1, wherein selecting one solution among the said solutions that provides the most financial benefits with minimal perturbation to the existing execution plan.

13. The method according to claim 1, wherein implementing said solution by creating new actions further comprises making efforts to modify an existing transaction first before creating a new transaction.

14. The method according to claim 1, wherein the step of evaluating is performed using non-stale real-time data.

15. A system for managing and optimizing a value chain in response to the new state of the value chain caused by events and exceptions in the value chain and creating an optimal new execution plan, comprising at least one computer, the computer capable of storing and executing a value chain management program thereon, the value chain management program having a plurality of functional components, including an intelligent execution model configured to:
retrieve latest information of a value chain from the database;
search for exceptions in the affected portion of said value chain;
construct potential solutions that optimize said value chain;
evaluate said solutions that optimize said value chain;
select one solution among the said solutions that provides the most financial benefits with minimal perturbation to an existing execution plan; and
implement said solution by creating new actions as part of said new execution plan.

16. The system according to claim 15, wherein the value chain management program further includes value chain components configured to receive transaction data pertaining to various transactions between the enterprise and one or more entities in the value chain.

17. The system according to claim 16, wherein the value chain management program further includes a value chain network configured to share the transaction data shared across the other components of the value chain management program.

18. The system according to claim 17, wherein the value chain management program further includes a distributed transaction backbone configured to process the transaction data and to manage execution of the various transactions across the value chain, and to generate new transactions as needed.

19. The system according to claim 15, wherein the intelligent execution module is further configured to detect exceptions in said portion of said value chain.

20. The system according to claim 15, wherein the intelligent execution module is further configured to construct said solutions to optimize said value chain.

21. The system according to claim 20, wherein the intelligent execution module is further configured to favor changes in far term over changes in near term in constructing said solutions that optimize said value chain.

22. The system according to claim 20, wherein the intelligent execution module is further configured to respect process constraints around existing business transactions in constructing said solutions that optimize said value chain.

23. The system according to claim 20, wherein the intelligent execution module is further configured to respect temporal constraints around existing business transactions in constructing said solutions that optimize said value chain.

24. The system according to claim 20, wherein the intelligent execution module is further configured to respect true dynamic capacity constraints in said value chain in constructing said solutions that optimize said value chain.

25. The system according to claim 20, wherein the intelligent execution module is further configured to respect the decisions and constraints imposed by other decision making agents in constructing said solutions that optimize said value chain.

26. The system according to claim 20, wherein the intelligent execution module is further configured to allow short-lived said exceptions to remain unresolved if the cost of resolution exceeds benefit of solution in constructing said solutions that optimize said value chain.

27. The system according to claim 15, wherein the intelligent execution module is further configured to calculate the cost and the financial benefit of said solutions.

28. The system according to claim 15, wherein the intelligent execution module is further configured to evaluate the impact of said solutions on said existing plan.

29. The system according to claim 15, wherein the intelligent execution module is further configured to make efforts to modify an existing transaction first before creating a new transaction.

30. The system according to claim 15, wherein the intelligent execution module is further configured to perform said evaluation using non-stale real-time data.

31. A system for managing a value chain of an enterprise comprising:
a graphic user interface;
a computer connected to said graphic user interface, said computer comprising a computer readable medium;
a plurality of instructions wherein at least a portion of said plurality of instructions are storable in said computer readable medium, and further wherein said plurality of instructions are configured to cause said computer to perform:
retrieving latest information of a value chain from the database;
searching for exceptions in the affected portion of said value chain;
constructing potential solutions that optimize said value chain;
evaluating said solutions that optimize said value chain;
selecting one solution among the said solutions that provides the most financial benefits with minimal perturbation to the existing plan; and
implementing said solution by creating new actions.
